(19) United States
(12) Patent Application Publication
(10) Pub. No.: US 2008/0233247 A1
(43) Pub. Date: Sep. 25, 2008

(54) Assemblable swinging lollypop

(76) Inventor: Rodolfo Fernandez, Kings Mountain, NC (US)

Correspondence Address: RODOLFO FERNANDEZ, 308 FULTON STREET, KINGS MOUNTAIN, NC, 28086, US

(21) Appl. No.: 11/725,529

(22) Filed: Mar. 19, 2007

(51) Int. Cl. A23G 3/56

(52) U.S. Cl. 426/134; 426/660

(57) ABSTRACT

An assemblable swinging lollypop, which comprises one or more replaceable edible pieces with diverse sizes, shapes, colors and flavors, provided with holes such that they are easily assemblable to a holding stick, provided, in turn, with sets of radial protuberances matching the holes in the edible pieces, and therefore this assemblable lollypop can be supplied assembled or unassembled in kits with separate pieces properly packaged, simplifying its manufacturing, and improving the user's amusement and entertainment with the option to assemble the lollypop in a great variety of combinations, with many alternate and attractive designs for its components and, in addition, as the union between the replaceable edible pieces and the holding stick is loose or articulated, the edible pieces are able to swing in relation to the holding stick when the user manually shakes the lollypop, adding to the consumer's amusement.

### CROSS REFERENCE TO RELATED APPLICATIONS

(Not Applicable)

### STATEMENT REGARDING FED. SPONSORED R & D

(Not Applicable)

### REFERENCE TO SEQUENCE LISTING

(Not Applicable)

### BACKGROUND OF THE INVENTION

This invention relates to lollypops and, particularly, to the way the lollypop edible part, usually a candy, is attached to its holding stick, consisting traditionally in a single edible part tightly fixed to disposable stick, so that both parts are rigidly joined and supplied in one piece, such that once the edible part of known lollypops is consumed, the stick is disposed of.

In their simple basic form, lollypops have been known for long time, and many different inventions have been developed relative to this type of candy but despite the numerous innovations and devices related to lollypops that have been created, one characteristic has remained unchanged in all of them: the factory made single candy piece tightly attached to one end of a disposable stick, manufactured and supplied assembled as a whole.

Thereof, since the elements integrating prior art lollypops are factory assembled and tightly joined, the user has no opportunity to assemble them by him-herself to enjoy diverse combinations as with this innovative invention, wherein instead of a simple disposable stick with a consumable candy attached to it, provides multiple replaceable candies with different color, flavor and shape which are assemblable, at the factory or by the user him-her-self, to a holding stick that, in addition, may be reusable.

The nearest prior art patent found is U.S. Pat. No. 3,264,115, by Davis, issued in 1966, but it refers to an articulated holding stick for lollypops as they usually are, with the edible piece tightly attached to a disposable stick at the factory.

In April 2000, it was granted to Manzone the U.S. Pat. No. 6,054,159, but it refers also to a lollypop with a candy tightly fit to a stick but with said stick split in order to provide self support on a plane surface, but completely assembled during the manufacturing process to the disposable stick.

In March 2006, it was granted to Lobl the U.S. Pat. No. 7,014,977, which refers to a lollypop with a split flexible stick that allows it to be bent in arcs in order to keep the lollipop within a protective compact case, but again the candy is rigidly fixed to the disposable stick at the factory.

Consequently, as in the examples mentioned above, many patents have been issued for improvements and novelties, and a great variety of designs has been introduced in the field of lollypops, but those patents have been always related to lollypops with factory made fixed and rigid union between the edible part and the holding stick, wherein said stick, which is disposable, exhibits special features such as flexibility, elasticity, slits for self-standing, edibility, etc.

On the other hand, though there are many inventions including replaceable candies to be consumed attached to holders, all of them refer to relatively complex holders which impart to the candy, or to the lollypop as a whole, motion and/or light and/or sound, and hence those patents belong to a very different classification and are much more complex and expensive than this innovative invention.

This assemblable swinging lollypop differs from prior art lollypops mainly in that it comprises one or more separate edible pieces with a hole, such that they can be replaceable and may be very easily assembled to a holding stick either at the factory or by the user, in such a way that the edible pieces remain attached to the holding stick with a loose union and are free to swing in relation to the stick when the user shakes the lollypop with his/her hand, adding the fun of said feature to the amusement provided by the easy assembling of the lollypop in varied combinations of one or more edible pieces with different flavors, colors and shapes, onto a same holding stick that, in addition, may be reusable.

### BRIEF SUMMARY OF THE INVENTION

For the assemblable swinging lollypop to accomplish its essential features, the replaceable candies have a hole which has in turn a constricted section or throat while the holding stick has resilient radial protuberances on the portion intended for the attachment of the candies or insertion end, in order to facilitate the assembling and keep the candies in the desired position, being said protuberances conveniently sized and shaped to match the holes and the throat within the replaceable edible pieces.

The sticks and the candies of this assemblable swinging lollypop are independently and separately manufactured, and may be supplied unassembled, propitiating the development of much more configuration alternatives for those main components of the lollypops.

It is an object of this invention, to provide lollypops consumers with a new and different kind of lollypop, comprising one or more replaceable edible pieces, usually candies, which, can be factory assembled or easily assembled by the user him-her-self to a holding stick with a loose union between the holding stick and the edible pieces, so that they may swing in relation to the holding stick when the lollypop is shaken by the user's hand.

A significant advantage of this invention for the confectioneries manufacturers is that the holding stick and the other components of the lollypop, which are produced independently, may be either factory assembled, or supplied unassembled in kits as separate parts individually wrapped within a package, to be manually assembled by the user.

Another object of this invention is the creation of lollypops with simple or elaborated holding sticks, as an independent and separate component, made of nontoxic plastics, or any other suitable material, which can be washable and reusable, and having as optional or alternate properties, elasticity or flexibility, or both properties combined to increase the random movements of the swinging pieces, improving the consumer's amusement.

Other advantage of this invention is that it makes possible to assemble lollypops with only one holding stick and one, two or more separate edible and inedible parts, stacked one above the other on the same stick in many combinations of sizes, flavors, colors and shapes.

Some of the independent inedible pieces may be merely decorative or perform the function of finger-guards, preventing the direct contact between the user's fingers and the edible components, thereby contributing to a cleaner and more hygienic handling of the lollypop while it is consumed.

In summary this novelty lollypop provides to the manufacturer the convenient and cheap option of packaging and supplying the lollypops in unassembled kits to be easily manually assembled by the user, reducing production costs and, at the same time, giving to the consumer the possibility to create different lollypops combinations, attaching to the holding stick in random order single or multiple replaceable edible and inedible pieces with diverse sizes, shapes, colors and flavors in the same lollypop.

These features and advantages, as well as others, will become evident to those skilled in the art through the drawings and their descriptions illustrating this invention, which constitutes, in a certain way, the creation of a new kind of lollypop.

### BRIEF DESCRIPTION OF THE DRAWINGS

FIG. 1A illustrates a perspective view of a preferred embodiment of this invention consisting in a holding stick to which are attached three spherical candies, stacked one above the other, held and shaken by the user's hand.

FIG. 1B illustrates an axial section slightly enlarged of the same embodiment shown in FIG. 1A.

FIG. 1C illustrates a partial section view of a magnified detail of the axial section of the embodiment shown in FIG. 1B.

FIG. 2A illustrates a perspective view of an alternate preferred embodiment of this invention where three candies resembling stylized flowers with different color and flavor are stacked onto the holding stick.

FIG. 2B illustrates an axial section view of the same embodiment shown in FIG. 2A.

FIG. 3 illustrates another possible embodiment of the invention consisting in a ramified holding stick resembling a plant stem with a swinging candy resembling a stylized flower similar to those shown in FIG. 2A, attached to each end of the ramified holding stick.

### DETAILED DESCRIPTION OF THE INVENTION

The assemblable swinging lollypop object of this invention comprises two basic components but may have as many supplementary components as desired. The two basic components are: a holding stick provided with resilient radial protuberances, and one or more replaceable swinging edible pieces provided with a hole conveniently configured.

The term holding stick is used because in this invention, though this main part of the lollypop can be almost as simple as in common lollypops, its particular features turn it into a more useful and special component, which can be washable and reusable.

The holding stick and the edible pieces in this invention differs of the sticks currently used in traditional or novelty lollypops, because instead of a factory made rigid tight union between the holding stick and the candy pieces, these are provided with holes and are loose and free to swing relative to the holding stick at the user's will, while remain securely retained by protuberances, which are either integral parts or independent attached elements of the holding stick.

The parts equivalent to the candy in conventional lollypops are often referred to as replaceable swinging candies or replaceable swinging edible pieces, because as explained above, among the main features of this invention, said parts are replaceable and may swing in relation to the holding stick when this innovative lollypop is shaken by the consumer's hand, thereof differing from known lollypops, in which those parts are molded around and tightly fixed to a disposable stick.

The swinging pieces in this assemblable swinging lollypop may be edible or inedible, because some of them can be made of non-toxic inedible plastic or any other suitable material to perform as decorative elements or as finger-guards, holding bases or other functions.

When edible, the swinging pieces are either candies or medicinal confectioneries and, in turn, when the swinging pieces are candies, they can be sugar based or dietetic, and when they are medicinal, can be prophylactic or therapeutic.

The holding stick of this innovative lollypop is provided with one or more sets of resilient or articulated protuberances and/or rigid stops integrated or attached to said holding stick, located around its longitudinal geometrical axis in a radial pattern, at sections along the portion of the stick intended for the attachment of the edible pieces or insertion end.

The resilient or articulated protuberances, in turn, can be unidirectional or bi-directional, with many different designs, provided that they accomplish their function of keeping the replaceable edible pieces, in sufficiently secure axial position, but allowing their free swinging movement in relation to the holding stick.

Both kind of sets of protuberances, resilient elements or rigid stops, may exhibit many different shapes, and may be located in different positions on the holding stick, but in all cases must be conveniently sized and shaped to be accommodated when expanded inside the edible pieces holes and to be able to collapse momentarily to pass through the throats or constricted section in said holes.

The holding sticks may be ramified with two, three or more branches, resembling little plant stems, or they may resemble little rattle snakes that may be bent and wound at will, or they may as well have many other shapes and features.

All components of this invention, in all their possible variations, can be produced using current manufacturing processes which allow high rates of production, are highly efficient and reliable, and are very well known in the fields of confectionery and injection molding.

In the consecutive drawings, the same or equivalent component or parts of components are designated with the same two last digits, according to their function rather than to its configuration, since there are a great number of different possible shapes for the same components, while the rest of the digits to the left designate the number of the figure in which the same component or part with the same function and shape has been referred to for the first time.

Some features of the assemblable swinging lollypop are explained below in the detailed description of the illustrative drawings, but the embodiments of the components may be many more than those shown in the following figures.

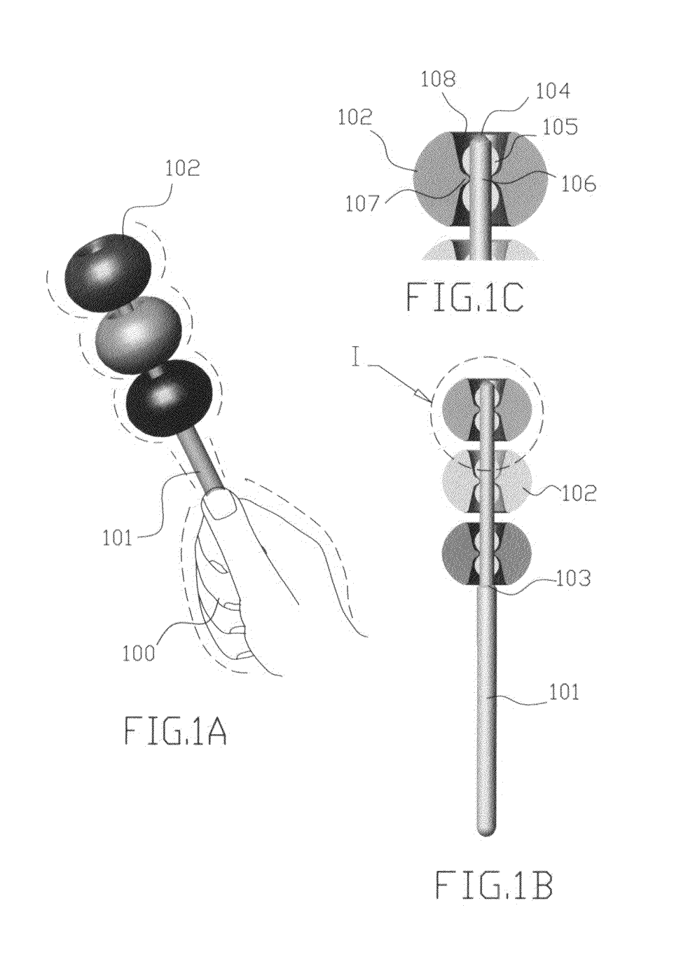

FIG. 1A illustrates a perspective view of a preferred embodiment of this invention consisting in a holding stick 101 to which are attached three replaceable swinging candies 102, shaped like spheres and stacked one above the other, while it is held and shaken by the user's hand 100, being the shaking motion indicated by the dotted lines around the contour of the figure.

FIG. 1B illustrates an axial section of the same embodiment shown in FIG. 1A, slightly enlarged, where can be seen the internal configuration of the holding stick 101 and the replaceable swinging candies 102, as well as the thicker edge 103 of the grip portion of the holding stick 101, surrounded by a dotted line circle indicating the Detail I which is shown magnified in the next figure.

FIG. 1C illustrates in enlarged partial section view the Detail I indicated in the embodiment shown in FIG. 1B.

In this figure can be seen the tip 104 of the insertion end of the holding stick, and the two uppermost sets of pairs of radial resilient protuberances 105, shaped like tiny thin round fins, forming between both of them a narrower cylindrical section or neck 106, where engages, after the assembling, the constricted inner edge or throat 107 located in the middle section of the hole 108 of the top replaceable swinging candy piece 102.

To assemble the replaceable swinging candies 102 to the holding stick 101 with the configuration shown for the sets of protuberances 105, the assembler should add a twisting action while pushing the end tip 103 of the holding stick 101 into the hole 108 of the replaceable swinging candies 102, in order to bend laterally the resilient thin tiny fin-like protuberances 105, until the throat 107 in the hole 108 reaches the desired position at the neck 106 between the two sets of protuberances 105, which may then resiliently expand recovering their normal radial position inside the wider section of the hole 108 within the replaceable swinging candies 102.

The union between the replaceable swinging candy 102 and the holding stick 101 as described above, is not tight, but loose enough to allow the swinging of the candy in relation to the holding stick when the user shakes the lollypop.

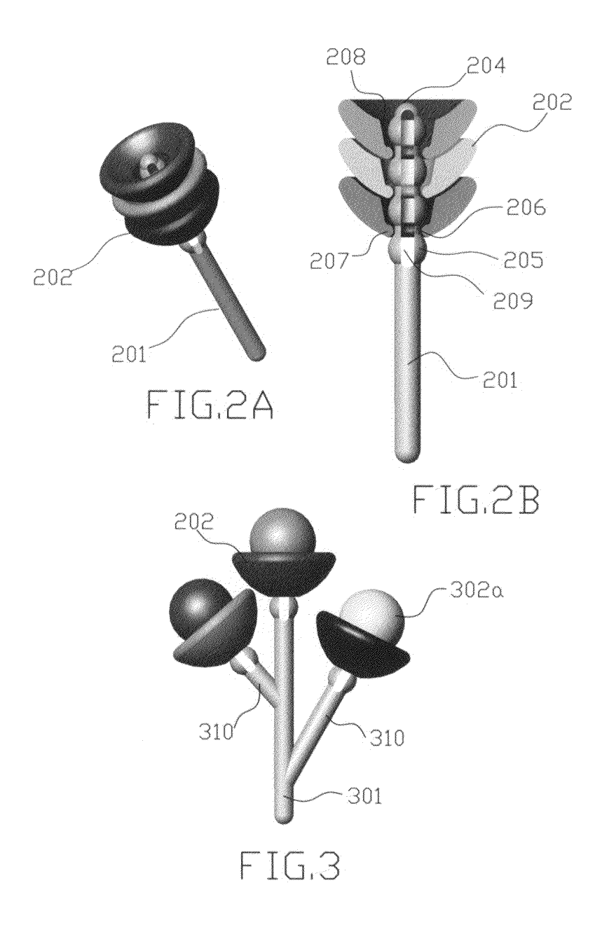

FIG. 2A illustrates a perspective view of an alternate preferred embodiment of this invention where three replaceable swinging candies 202 resembling stylized flowers with different color and flavor are stacked onto the holding stick 202.

FIG. 2B illustrates an axial section view of the same alternate embodiment shown in FIG. 2A, where it can be seen that the holding stick 201 is provided with four sets of resilient radial protuberances 205 with the shape of semi-spheres separated by an axial slot 209 and forming necks 206 between each pair of sets of protuberances, while the three replaceable swinging candies 202 with the shape of stylized flowers stacked one above the other onto the holding stick, have the throats 207 located at the lowest section of the holes 208, engaged at the necks 206.

With this design of resilient radial protuberances 205, to assemble the replaceable candies 202 to the holding stick 201, it is only necessary to push the tip 204 of the holding stick 201 into the hole 108 of the replaceable swinging candies 202, in such a manner that the pair of resilient rounded protuberances 205 are depressed inwardly, briefly collapsing the slot 209 between them to pass through the throat 207, and then recovering their expanded normal position inside the wider section of the hole 208 into the replaceable swinging candies.

The assembling operation may be repeated for each replaceable swinging candy piece that the user attaches, which can be one, two or more, according to the design of the holding stick of the assemblable swinging lollypop that, in turn, may have different quantity of sets of protuberances.

In all cases, the protuberances on the holding stick must be conveniently sized and shaped to properly match expanded inside the holes within the replaceable edible pieces, and to be able to collapse when passing through the throats in said holes.

If more than one candy are attached to the stick, the user has the option to displace the remaining candies to the top of the holding stick as the top candy has been consumed.

When all the candies on the holding stick have been consumed, the user has the option to replace the consumed candies with new ones.

FIG. 3 illustrates another possible embodiment of the invention with a ramified holding stick resembling a plant stem 301 with two branches 310, and a replaceable swinging candy 202 resembling a stylized flower similar to those shown in FIG. 2A, attached to each end of the ramified holding stick.

In this case, each swinging candy is filled with an edible substance 302a, which may be chocolate, marshmallow or any other tasty substance, as well as an additional candy piece properly inserted.

Since in the assemblable swinging lollypop the holding stick may be washable and reusable, the user has the option to save the holding stick for future use.

The above description with reference to the figures is considered to be illustrative and not restrictive. The true scope and spirit of the invention resides in the appended claims and their legal equivalents, rather than in the given examples. Modifications and variations on the embodiments described, or known to those skilled in the art, may be made within the scope of the invention.

What is claimed as invention is:

1. An assemblable swinging lollypop comprising at least one edible piece attached to one end or insertion end of a holding stick, while the opposite end of said holding stick is the grip portion of the stick to be held by the user's hand, wherein said edible piece is replaceable and provided with a hole and said holding stick has its insertion end provided with one or more sets of resilient radial protuberances, forming one or more narrow sections or necks, such that said edible piece is easily assembled by hand to said holding stick, while the union between said edible piece and said holding stick, instead of being tight and rigid as in prior art lollypops, is loose and thereof said edible piece is free to swing relative to said holding stick, when the assemblable swinging lollypop is shaken by the user, thereby adding to the consumer's amusement.

2. An assemblable swinging lollypop as set forth in claim 1, wherein the hole in said replaceable swinging edible piece has at least one outer opening and an inner constricted section or throat shaped and sized to enter the insertion end of said holding stick, when are forced to collapse said sets of resilient radial protuberances at said insertion end to pass through said throat and after having passed through said throat, said sets of resilient radial protuberances expand inside said hole in said replaceable swinging edible piece while said throat engages at said neck on said holding stick, keeping said replaceable swinging edible piece assembled to said holding stick.

3. An assemblable swinging lollypop as set forth in claim 1, wherein said holding stick has one grip portion ramified in multiple insertion ends each provided with sets of resilient radial protuberances such that to each of said insertion ends are assembled replaceable swinging edible pieces with assorted shapes, colors and flavors.

4. An assemblable swinging lollypop as set forth in claim 1, wherein said holding stick is washable and reusable.
